(19) United States
(12) Patent Application Publication
(10) Pub. No.: US 2010/0314381 A1
(43) Pub. Date: Dec. 16, 2010

(54) Heating device

(76) Inventor: Ching Chuan Wang, Chidu (TW)

Correspondence Address: Muncy, Geissler, Olds & Lowe, PLLC, 4000 Legato Road, Suite 310, FAIRFAX, VA, 22033, US

(21) Appl. No.: 12/010,662

(22) Filed: Jan. 28, 2008

(51) Int. Cl. H05B 1/02

(52) U.S. Cl. 219/494

(57) ABSTRACT

A heating device is disclosed. The heating device has a heating line and at least one thermo-responsive means received in a bag, wherein the heating line and the thermo-responsive means are respectively connected to a controller. The thermo-responsive means comprises an housing with an integrated positioning hole, wherein one end of a first light cable and a second cable respectively passes through the two ends of the positioning hole so as to transmit light signals emitted/received by an optical signal transmitter/receiver module, and wherein an optical interrupter member is positioned between the first light cable and the second cable and one end of the optical interrupter member is movable if heated, such that the end of the optical interrupter member can interrupt or permit the transmission of light signals when the heating line generates heat and the interior temperature of the bag reaches a set point temperature to keep the heating temperature within a temperature range.

### BACKGROUND OF THE INVENTION

1. Field of the Invention

The present invention is related to a heating device, and particularly to the use of at least one thermo-responsive means for detecting the interior temperature of a bag and the use of a controller for control the heating of heating line to keep the heating temperature within a temperature range.

2. Description of the Prior Art

In modern busy business society, office workers usually spend most of their time sitting. Office work with static body positions most often causes muscle tension, reduces the flow of blood to the muscles, and impairs blood circulation. Some office workers, affects are the back, limbs, neck and shoulders caused by Blood circulation disorders have traditionally been seen as problems associated with

The solution of addressing such problems has been recognized that moderate muscle exercises are the best solution for the problems described above to increase blood circulation and decrease fatigue for keeping body physically and mentally alert. However, not every office worker could patiently do exercises, and some workers even do not have time for exercises. Therefore, many people expect to improve blood circulation throughout the body to keep the body warm by various heating devices sold on market (i.e., heating pad or heating blanket).

Referring to FIG. 6 showing a electrical circuit of heating pad quite widely sold in the markets presently, wherein mainly a heating line b is disposed in a meandering manner within a cover bag a. Both ends of the heating line b are connected to a controller c for users to preset heating temperature and heating time, and for allowing the heating line to maintain its temperature below a predetermined temperature during a fixed time. The method to control temperature mentioned above is to cut off the heating line b and install a bimetal switch therebetween. When the temperature of the heating line b reaches a predetermined temperature, the bimetal switch is moved if heated and automatically turned off; in the other hand, the bimetal switch is retrieved and turned on when the temperature descends to allow the heating of heating line b, and thereby control the temperature of heating pad efficiently. However, the structure mentioned above still has some problems in use:
1. Because the heating line and the bimetal switch are in the same electrical circuit, the circuit insulation therebetween must be enhanced to prevent leakage of electricity, and this would increase manufacturing cost.
2. The repetitively switching of the bimetal switch may cause an electric arc, and this undesired electric arc has detrimental effects on the bimetal switch, inducing oxidization on the surface of the bimetal switch and subsequently impairing the switch. Further, the electric arc effect may results in a very high temperature at the metal switch, and the bimetal switch will melt together causing the switch to be electrically connected and heated, thereby a danger of conflagration can be induced.

For the problems mentioned above, there is a need for an improved heating device with low manufacturing cost and guaranteed usage safety to overcome the shortcomings of the prior art.

### SUMMARY OF THE INVENTION

The primary object of the present invention is to provide a heating device, wherein at least one thermo-responsive means is disposed in a bag for detecting the temperature of heating lines inside the bag, and thereby controls the heating of the heating lines by the thermo-responsive means without connection so as to save manufacturing cost and prevent leakage of electricity.

A secondary object of the present invention is to provide a heating device, wherein at least one thermo-responsive means is disposed in a bag, and the thermo-responsive means has a bimetal member for detecting the temperature of heating lines inside the bag, and for interrupting or forming transmission of light signals to control the heating of the heating lines and prevent a short-circuit in the heating lines.

In order to achieve the above stated objects of the present invention, the heating device according to the present invention comprises a bag with a heating line received in the bag. The heating line is connected to a controller for controlling temperature to be generated by heating of the heating line. The bag is further equipped with at least one thermo-responsive means for detecting the temperature inside the bag. The thermo-responsive means includes a housing with a positioning hole; an optical signal transmitter/receiver module connecting to the controller; a first light cable with one end connected to the optical signal transmitter/receiver module for transmitting light signals and the other end positioned in one end of the positioning hole; a second light cable with one end connected to the optical signal transmitter/receiver module for receiving light signals and the other end positioned in the other end of the positioning hole; and an optical interrupter member with one end fixed to the housing while the other end is disposed between the first/second light cable and is movable if heated for interrupting or permitting transmission of light through the first/second light cable when temperature inside the bag reaches desired temperature to control heating temperature of the heating line.

In practicing, the positioning hole is a straight hole.

In practicing, the optical interrupter member is a bimetal member capable of bending in one direction when heated.

In practicing, the thermo-responsive means are series connected.

The present invention will be apparent after reading the detailed description of the preferred embodiments in reference to the accompanying drawings.

### BRIEF DESCRIPTION OF THE DRAWINGS

FIG. 1 is a perspective view of the first embodiment of the present invention;

FIG. 2 is a sectional view showing the structure of a thermo-responsive means of the first embodiment;

FIG. 3 is a perspective view illustrating the status of the present invention in use;

FIG. 4 is another perspective view illustrating the status of the present invention in use;

FIG. 5 is a perspective view of the second embodiment of the present invention; and

FIG. 6 is a perspective view showing of electrical circuit of a conventional heating pad.

### DETAILED DESCRIPTION OF THE PREFERRED EMBODIMENT

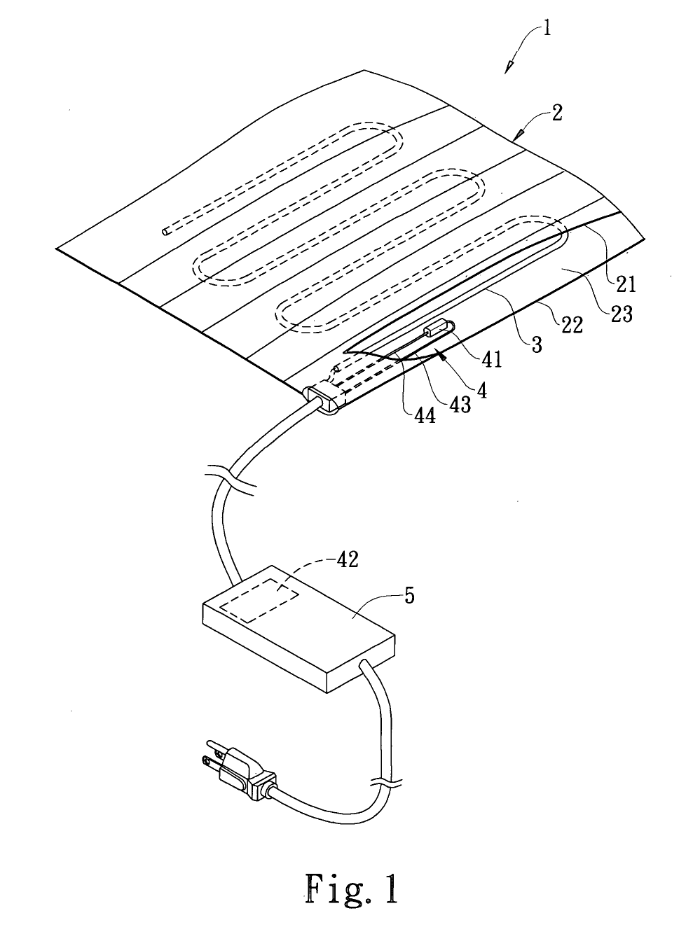

Referring to FIGS. 1, showing a first embodiment of a heating device 1 of the present invention, the heating device 1 comprises a bag 2, a heating line 3 and thermo-responsive means 4 received in the bag 2, and a controller 5 connecting to the heating line 3 and the thermo-responsive means 4 for controlling temperature generated by heating of the heating line 3.

The bag 2 is formed by lap connecting of a surface layer 21 and a bottom layer 22; the bag 2 has therein a receiving space 23. The heating line 3 is positioned in the receiving space 23 between the surface layer 21 and the bottom layer 22 of the bag 2 in a linear orientation parallel to each other. The controller 5 is connected between the heating line 3 and an electric power source to make the heating line 3 be heated under the control of the controller 5, and to adjust the time for heating; the structures of the heating line 3 and the controller 5 are those well known to one skilled in the art.

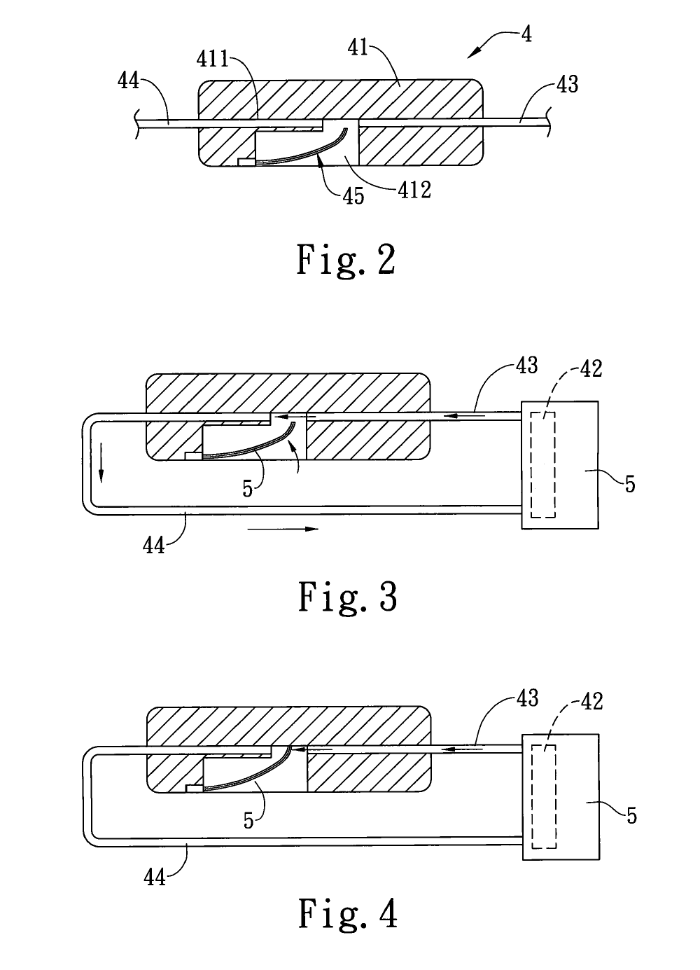

Referring to FIGS. 1 and 2, the thermo-responsive means 4 includes a housing 41, an optical signal transmitter/receiver module 42, a first light cable 43, a second light cable 44, and an optical interrupter member 45.

The housing 41 is a rectangle box with interior parts having a longitudinal straight hole as a positioning hole 411 and a receiving space 412, wherein the receiving space 412 communicates with the central part of the positioning hole 411.

The optical signal transmitter/receiver module 42 is disposed in the internal part of the controller 5 to connect to an electric circuit of the controller 5. The optical signal transmitter/receiver module 42 includes a light-emitting diode and a light-receiving diode for emitting and receiving light signals. The optical signal transmitter/receiver module 42 also may include an infrared-emitting diode and an infrared-receiving diode, or elements with similar functions.

The first light cable 43 and the second light cable 44 are optical fibers, wherein the first light cable 43 has one end connected to the light-emitting diode of the optical signal transmitter/receiver module 42 and the other end passing through and fixed to the right end of the positioning hole 411; the second light cable 44 has one end connected to the light-receiving diode of the optical signal transmitter/receiver module 42 and the other end passing through and fixed to the left end of the positioning hole 411

The optical interrupter member 45 is a bimetal member in an arc shape composing of two separate metals joined together, which converts a temperature change into mechanical displacement. The optical interrupter member 45 is disposed in the receiving space 412 of the housing 41 with one end fixed onto the housing 41 and the other end positioned in the lower space of the first light cable 43 and the second light cable 44.

Referring to FIGS. 1 and 3, when the light-emitting diode of the optical signal transmitter/receiver module 42 emits light signals, the light signals are sent to the light-receiving diode in the controller 5 through the first light cable 43 and the second light cable 44 to form a circuit, and allow the heating line 3 to keep on heating. As shown in FIGS. 1 and 4, when the heating line 3 maintains its continuous heating operation, and the temperature in the receiving space 23 of the bag 2 reaches a set point temperature, the bimetal member will bend upwardly if heated, and move to the space between the first light cable 43 and the second light cable 44 such that the light signals from the first light cable 43 is interrupted. In this manner, once the controller 5 receives a message that the light signals are interrupted, it will cut off the circuit of the heating line 3 to stop heating, and control the temperature of the bag 2 to within a temperature range.

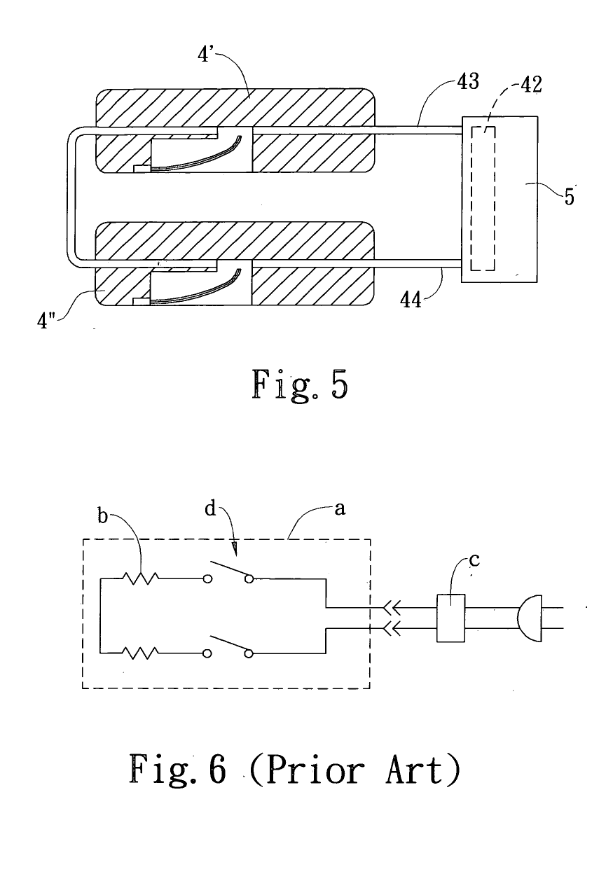

Referring to FIG. 5, showing a second embodiment of a heating device 1 of the present invention, the heating device 1 includes two thermo-responsive means 4′ and 4″, wherein the right end of the thermo-responsive means 4′ is connected to one end of the first light cable 43, and the left end of the thermo-responsive means 4′ is connected to one end of a third light cable 46′; the other end of the third light cable 46′ passes through and fixed to the left end of another thermo-responsive means 4″ such that the two thermo-responsive means 4′ and 4″ are series connected.

Therefore, the present invention has the following advantages:
1. Due to the relatively simple design, the present can detect the temperature inside the bag and control the heating of the heating line without any electric circuit. As such, the present invention can prevent electrical leakage and save the manufacturing cost.
2. By the physical property of bimetal member which convert a temperature change into mechanical displacement, the bimetal member can efficiently interrupt or form the transmission of light signals to control the heat generated by the heating line, and ensure the usage safety in practice.
3. The thermo-responsive means of the present invention does not connect to any electrical circuit so as to prevent the adverse consequences that can result from oxidation of the switch or the electric arc effect that can cause a breakdown on the heating line, to prolong the life of product.
4. The present invention can more precisely detect the temperature on every section of the heating line by arranging a plurality of series connected thermo-responsive means alongside the heating line.

As stated in the above disclosed, the present invention can surely achieve its expected objects to provide a heating device capable of ensuring the usage safety in practice and provides little or no additional cost of materials or in labor associated with manufacture.

It should be understood that different modifications and variations could be made from the disclosures of the present invention by the people familiar in the art without departing the spirit of the present invention.

1. A heating device comprises a bag having a heating line received in the bag and connected to a controller for controlling temperature generated by heating of the heating line characterized in that the bag is equipped with at least one thermo-responsive means for detecting the temperature inside the bag, the thermo-responsive means comprising:
a housing with a positioning hole;
an optical signal transmitter/receiver module connected with the controller;
a first light cable with one end connected to the optical signal transmitter/receiver module for transmitting light signals and the other end positioned in one end of the positioning hole;
a second light cable with one end connected to the optical signal transmitter/receiver module for receiving light signals and the other end positioned in the other end of the positioning hole; and
an optical interrupter member with one end fixed to the housing while the other end is disposed between the first and second light cables and is movable if heated for interrupting or permitting transmission of light signals through the first and second light cables when temperature inside the bag reaches desired temperature to control heating temperature of the heating line.

2. The heating device as in claim 1, wherein the positioning hole is a straight hole.

3. The heating device as in claim 1, wherein the optical interrupter member is a bimetal member capable of bending in one direction when heated.

4. The heating device as in claim 1, wherein the thermo-responsive means are series connected.

5. The heating device as in claim 1, wherein the optical signal transmitter/receiver module includes a light-emitting diode and a light-receiving diode.

6. The heating device as in claim 1, wherein the optical signal transmitter/receiver module includes an infrared-emitting diode and an infrared-receiving diode.
